(19) United States
(12) Patent Application Publication
(10) Pub. No.: US 2015/0136921 A1
(43) Pub. Date: May 21, 2015

(54) ACCESSORY HOLDER FOR STACKABLE CHAIR

(71) Applicant: BERTOLINI CORPORATION, Chino, CA (US)

(72) Inventors: Bruce Prock, Rancho Cucamonga, CA (US); Charles Horn, Moreno Valley, CA (US); James Bertolini, Covina, CA (US)

(21) Appl. No.: 14/493,532

(22) Filed: Sep. 23, 2014

Related U.S. Application Data
(60) Provisional application No. 61/904,933, filed on Nov. 15, 2013.

(51) Int. Cl. A47C 7/62; F16M 13/02

(52) U.S. Cl. CPC A47C 7/62; F16M 13/02
USPC 248/205.1

(57) ABSTRACT

The present invention is an accessory holder for an upholstered stackable chair, comprised of (1) a molded outer shell open at the top and partially closed on the bottom with one inset slot offset from the top and the left and a communion cup shaped recessed area in the upper right, (2) a molded inner protective pencil shell with stop, and (3) a molded loop. The invention can be used in a religious worship setting (1) to store, and distribute visitor response cards, envelops, business cards, (2) to store an instrument of writing, and (3) to store communion cups after use. Furthermore, it should be noted that the present invention is designed to conform to both straight and contoured upholstered backs and that the molded loop is designed to pivot downward when in use as a communion cup holder and to pivot upward and out of the way to eliminate interference when chairs are stacked.

### BACKGROUND OF THE INVENTION

1. Field of the Invention

The present invention relates generally to an upholstered stackable chair accessory holder for response cards, envelops, business cards, pencils, communion cups.

2. Background

Currently there are a number of solutions for holding accessories on chairs. Some of these solutions attempt hold some of the desired accessories for chairs used in religious worship services, but these solutions fail to meet the needs of the industry because they tend to be big and bulky and esthetically displeasing and they do not allow for application to stackable chairs without interfering with stacking. Other solutions attempt to provide accessory holding for stackable chairs, but these solutions are similarly unable to meet the needs of the industry because they are not tailored to the specific accessory needs of the typical religious gathering, tend to be bulky and cumbersome and are not applicable to both contoured and straight backs. Still other solutions seek to provide capacity to hold just cards or pencils or both, but these solutions also fail to meet industry needs because they do not provide a communion cup holder and a place for smaller business cards or wider response cards.

It would be desirable to have an upholstered stackable chair accessory holder which can simultaneously hold response cards, envelops for donations, business cards and instruments of writing for marking on said items. Furthermore, it would also be desirable to have said holder have capacity to hold communion cups after use by worshippers of religious gatherings. Still further, it would be desirable to have said holder be applicable to either straight or contoured backs of upholstered stable chairs and maintain a compact depth profile so that it does not interfere with stacking. Therefore, there currently exists a need in the industry for such an accessory holder which conforms to the back of a straight or contoured upholstered stackable chair and maintains a compact depth profile allowing for stacking.

### SUMMARY OF THE INVENTION

The present invention advantageously fills the aforementioned deficiencies by providing an upholstered stackable chair accessory holder for response cards, envelops, business cards, pencils and communion cups which provides a place to store, display and distribute visitor response cards, envelops for donations, business cards, a place to store an instrument of writing for marking on said items, and a place to store communion cups after use by worshippers. Furthermore, it should be noted that the present invention is designed to conform to both straight and contoured upholstered backs of stackable chairs and to maintain a compact depth profile allowing the present invention to stay in place without interference to stacking.

The present invention is an accessory holder for an upholstered stackable chair, which is made up of the following components, an outer shell, an inner shell, and a loop. These components are connected as follows: the inner shell and the loop snap into the outer shell.

The present invention may also have one or more of the following: recessed slots for business cards; pencil stops, a perforated bottom allowing application to a contoured back, clear or translucent material makeup for better esthetics on an upholstered chair, however, is functional in any color desired.

The present invention is unique when compared with other known devices and solutions because the present invention provides: (1) an accessory holder for response cards, envelops, informational flyers, business cards, invitation cards, pencils, and communion cups (2) the above designed to mount on either straight or horizontally curved backs of an upholstered stackable chair by dynamically adapting to the back's horizontal contour (3) the above with a compact depth profile that allows for stackable chairs to be stacked without interference (4) the above that is accomplished with a pivoting loop that holds communion cups when down but pivots up out of the way as chairs are stacked.

The present invention is unique in that it is structurally different from other known devices or solutions. More specifically, the present invention is unique due to the presence of: (1) the pivoting loop that holds communion cups when down yet pivots up out of the way thus not interfering with stacking; (2) the recessed card slot for smaller form-factor cards such as business cards; and (3) partially open and perforated bottom that allows for application to either straight or contoured backs.

Among other things, it is an object of the present invention to provide an upholstered stackable chair accessory holder for response cards, envelops, business cards, pencils and communion cups that does not suffer from any of the problems or deficiencies associated with prior solutions.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRPTION OF THE DRAWINGS

FIG. 1 show the present invention complete with all components intact

FIG. 2 shows the present invention with components exploded

FIG. 3 shows the detail of the molded loop and functional pivot action to allow clearance for stacking of chairs

FIG. 4 shows the detail of the snap in inner shell with pencil stop and holder

FIG. 5 shows the details on the small form-factor card slot

FIG. 6 shows the detail on the bottom outer shell which is perforated and partially open to allow for application to curved and straight backs

FIG. 7a shows a side-view depth profile of the present invention when the loop is pivoted down for use while FIG. 7b shows the compact depth profile desirable for stacking with the loop pivoted up

FIG. 8a shows the present invention installed on a contoured chair back while FIG. 8b shows the present invention installed on a straight chair back

FIGS. 9a and 9b show the several of the present invention applied to chairs which are in the stacked position

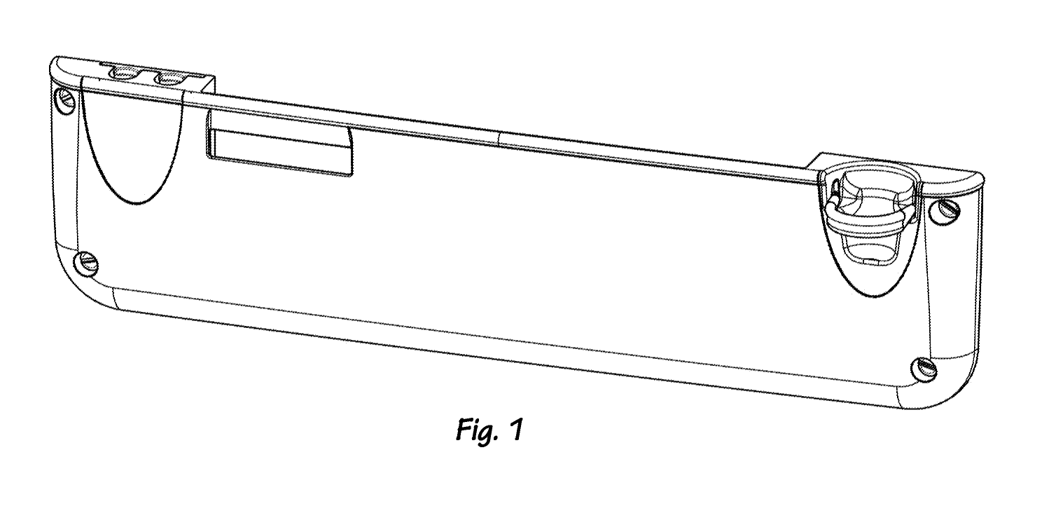

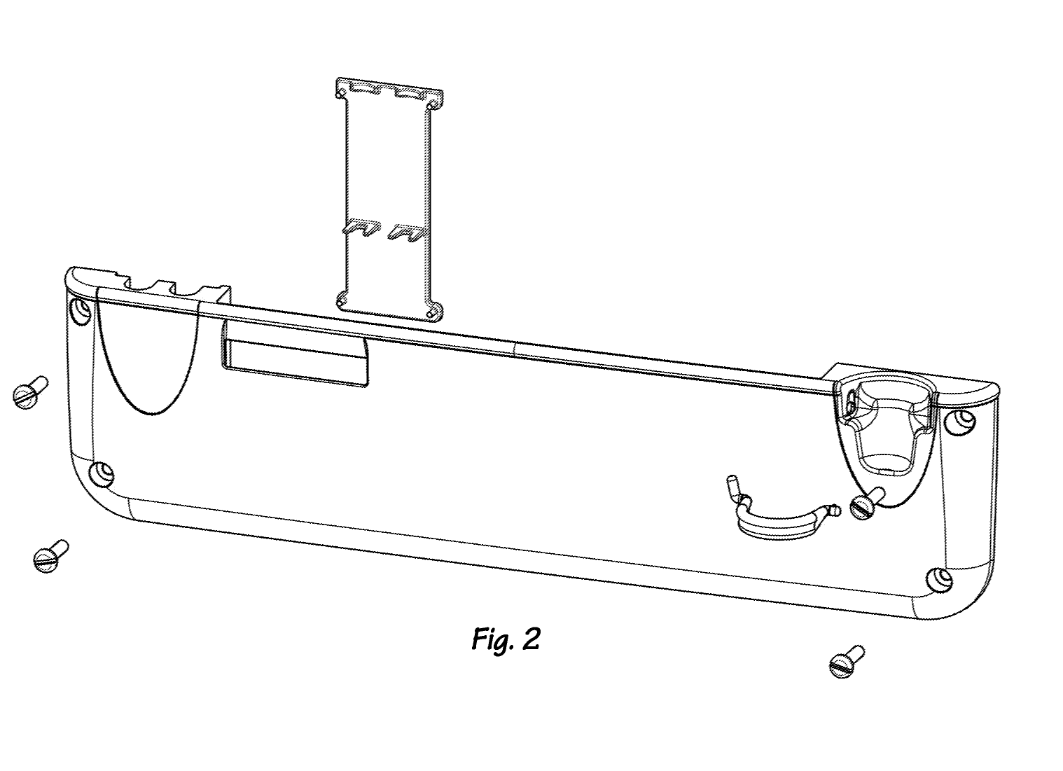

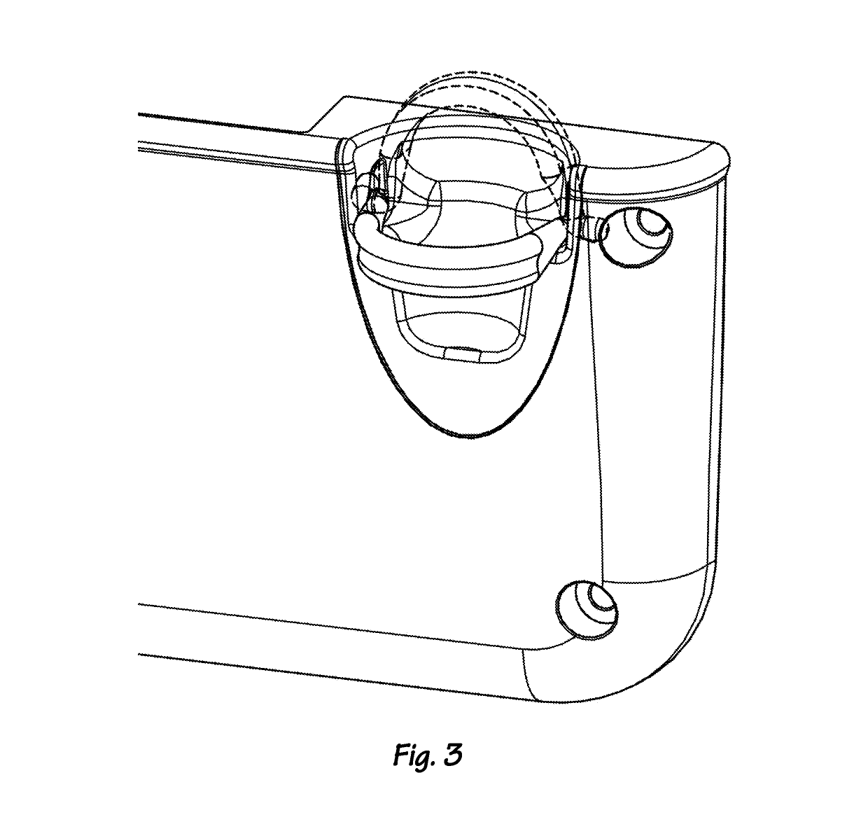

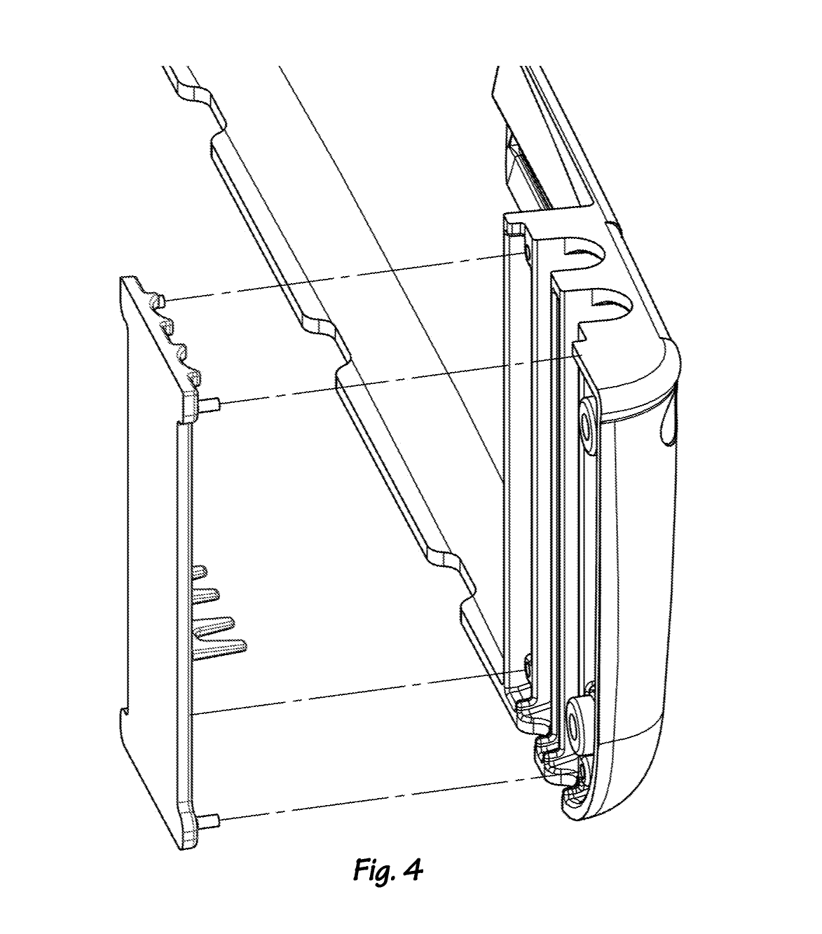

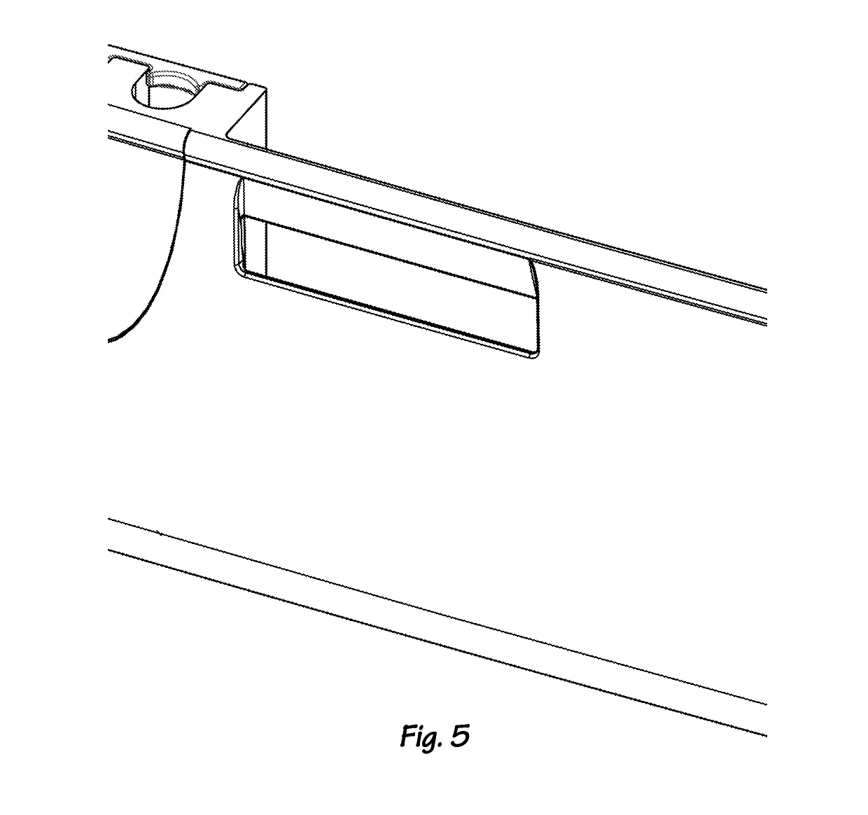

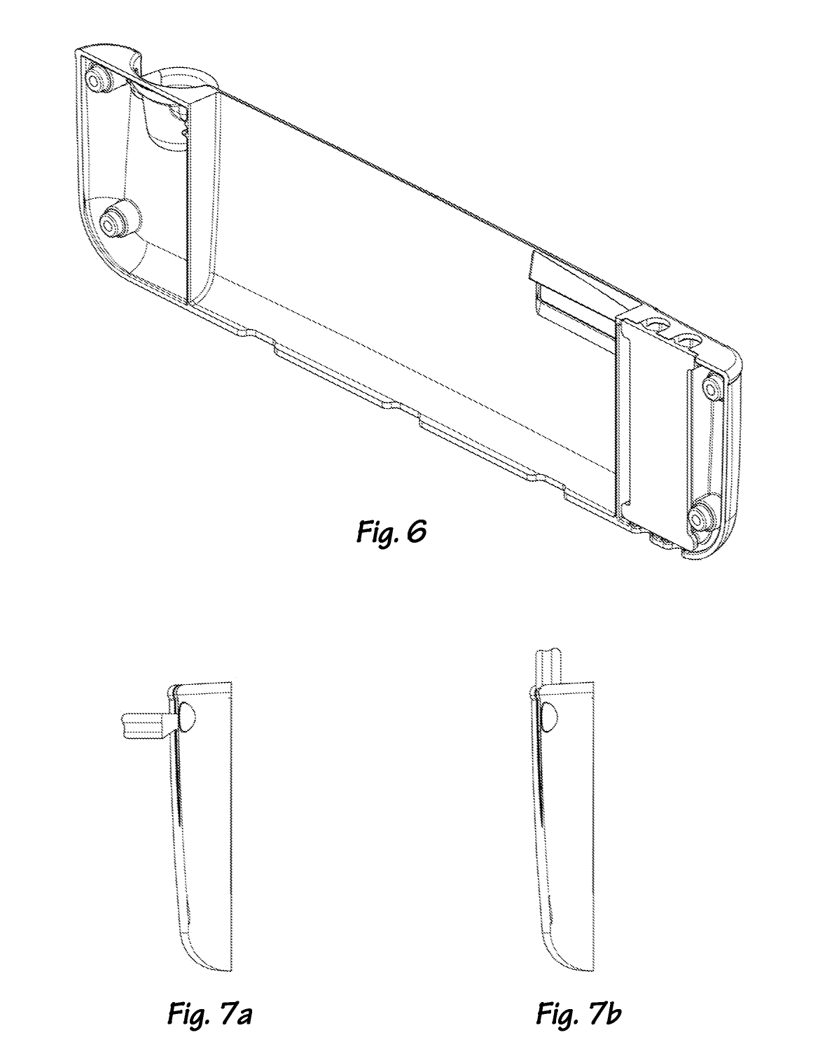

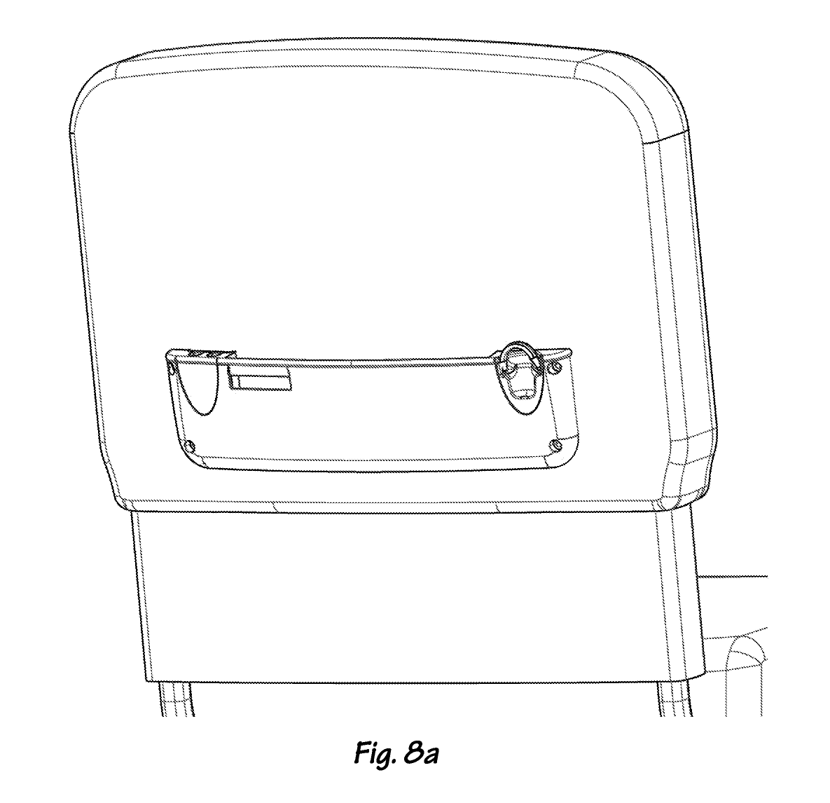

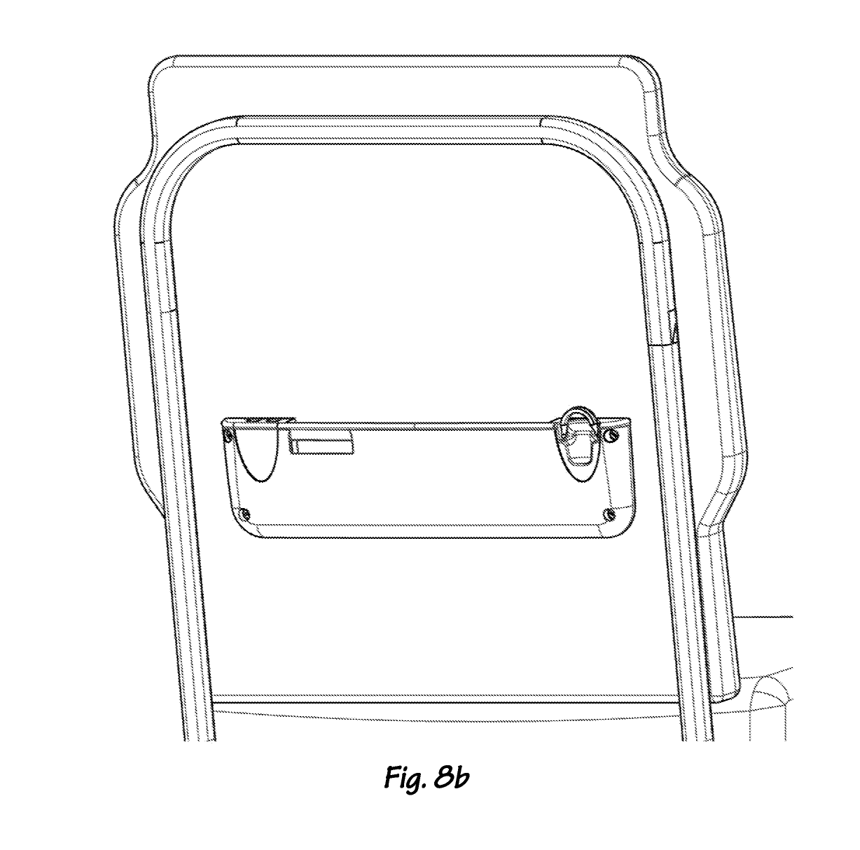

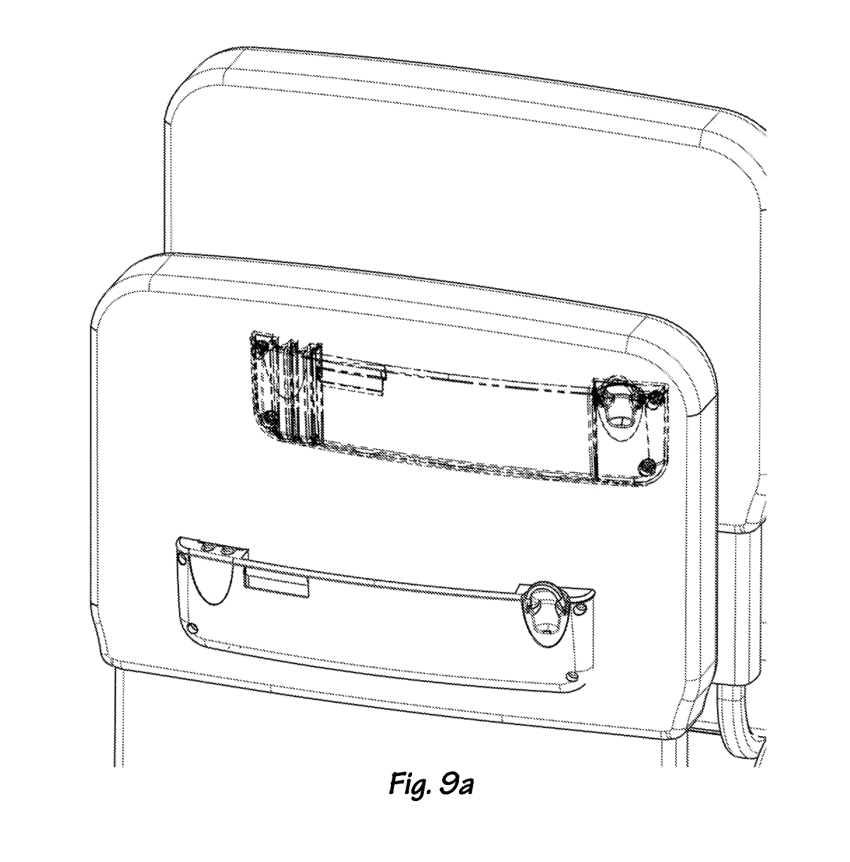

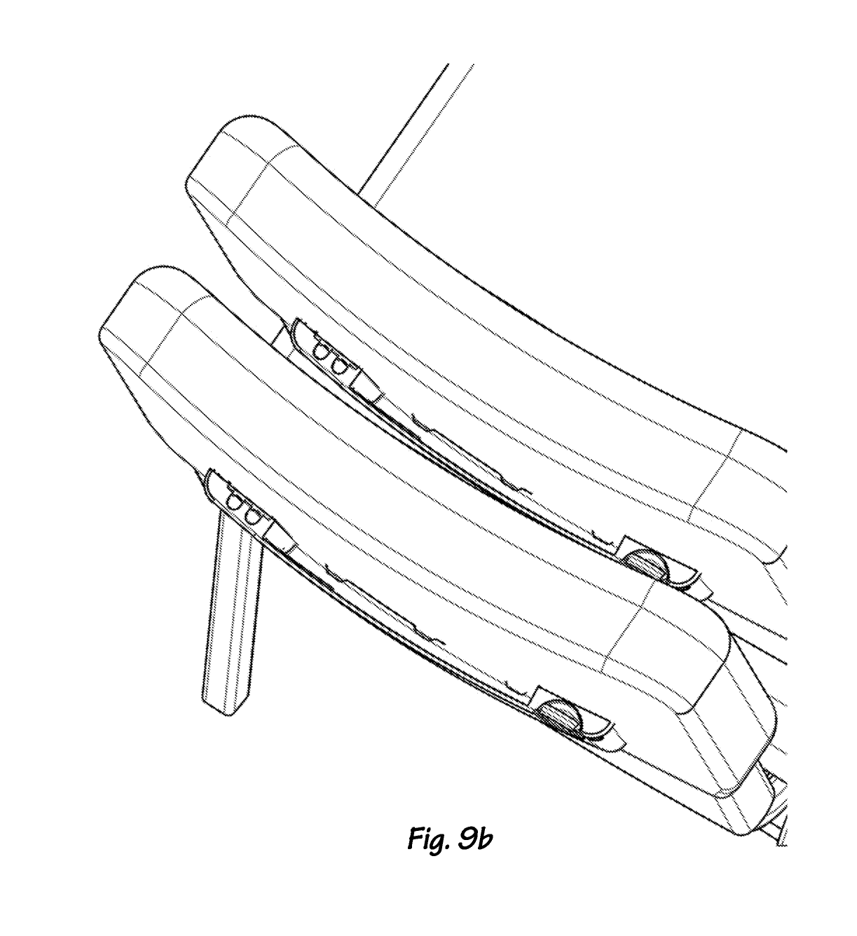

### DETAILED DESCRIPTION OF THE INVENTION

The present invention is directed to an upholstered stackable chair accessory holder for response cards, envelops, business cards, pencils, communion cups.

In its most complete version, the present invention is made up of the following components: (1) a molded outer shell that is open at the top and partially closed and perforated on the bottom with one inset slot offset from the top and the left and a communion cup shaped recessed area in the upper right, (2) a molded inner protective pencil shell that also has a stop to prevent pencils from falling or marking the back of the chair, and (3) a molded loop. These components are connected as follows: (1) the molded loop snaps into a recessed area in the upper right of the outside of the molded outer shell; (2) the molded inner protective pencil shell snaps into the left side of the back of the molded outer shell; (3) the completed unit is attached to the back of an upholstered stackable chair. The invention can be used in a religious worship setting (1) to store, display and distribute visitor response cards, envelops for donations, business cards, (2) to store an instrument of writing for marking on said visitor response cards, envelops for donations, business cards, and (3) to store communion cups after use by worshippers. Furthermore, it should be noted that the present invention is designed to conform to both straight and contoured upholstered backs and that the molded loop is designed to pivot downward extending from the outer molded shell when in use as a communion cup holder and to pivot upward and out of the way maintaining a compact depth profile allowing the present invention to stay in place without interference when chairs need to be stacked.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. An accessory holder for response cards, envelops, informational flyers, business cards, invitation cards, pencils, and communion cups made of (1) a molded outer shell that is open at the top and partially closed and perforated on the bottom with one inset slot offset from the top and the left and a communion cup shaped recessed area in the upper right, (2) a molded inner protective pencil shell that also has a stop to prevent pencils from falling or marking the back of the chair, and (3) a molded loop. Wherein (1) the molded loop snaps into a recessed area in the upper right of the outside of the molded outer shell, and (2) the molded inner protective pencil shell snaps into the left side of the back of the molded outer shell composing a completed unit designed to conform to either a straight and contoured upholstered back of an upholstered stackable chair.

2. The accessory holder of claim 1, wherein the molded loop is designed to pivot downward extending from the outer molded shell when in use as a communion cup holder and to pivot upward and out of the way maintaining a compact depth profile allowing the present invention to stay in place without interference when chairs need to be stacked.
